(19) United States
(12) Patent Application Publication
(10) Pub. No.: US 2010/0021778 A1
(43) Pub. Date: Jan. 28, 2010

(54) FUEL CELL EMERGENCY POWER SYSTEM

(75) Inventors: Jeremy D. Steinshnider, Bryan, TX (US); Mark J. Flushe, College Station, TX (US); Oliver J. Murphy, Bryan, TX (US)

Correspondence Address: STREETS & STEELE, 13100 WORTHAM CENTER DRIVE, SUITE 245, HOUSTON, TX, 77065, US

(73) Assignee: Lynntech, Inc., College Station, TX (US)

(21) Appl. No.: 12/490,486

(22) Filed: Jun. 24, 2009

Related U.S. Application Data
(60) Provisional application No. 61/083,729, filed on Jul. 25, 2008.

(51) Int. Cl. H01M 8/00; H01M 2/02; H01M 8/18; H01M 8/04; B01D 19/00; B01D 21/30

(52) U.S. Cl. 429/13; 429/34; 429/19; 429/17; 429/22; 210/188; 210/143

(57) ABSTRACT

Fuel cell emergency power systems comprising a fuel cell having an anode and a cathode, a power distribution unit for selectively directing electrical current from the fuel cell to one or more consuming device, a hydrogen gas control system and an oxygen gas control system. The hydrogen gas control system includes a pressurized hydrogen tank providing hydrogen gas in selective fluid communication to the anode, a hydrogen gas-liquid water phase separator in downstream fluid communication with the anode, and a hydrogen recirculation pump for recirculating substantially liquid water-free hydrogen from the hydrogen gas-liquid water phase separator to the anode. Similarly, the oxygen gas control system includes a pressurized oxygen tank providing oxygen gas in selective fluid communication to the anode, an oxygen gas-liquid water phase separator in downstream fluid communication with the anode, and an oxygen recirculation pump for recirculating substantially liquid water-free oxygen from the oxygen gas-liquid water phase separator to the anode.

### CROSS REFERENCE TO RELATED APPLICATIONS

This application claims priority of U.S. provisional patent application 61/083,729 files on Jul. 25, 2008.

### BACKGROUND OF THE INVENTION

1. Field of the Invention

The present invention relates to passive gas-liquid separator vessels.

2. Background of the Related Art

A ram air turbine (RAT) is a small turbine and connected hydraulic pump or electrical generator used as an emergency power source for aircraft. In case of a loss of both primary and auxiliary power sources, the RAT will power vital systems, such as flight controls, linked hydraulics and flight-critical instrumentation. Some RATs produce only hydraulic power, which may then be used to power electrical generators.

The RAT generates power from the air stream due to the speed of the aircraft. If aircraft speeds are low, the RAT will produce less power. Depending upon the size and speed of the aircraft, the RAT may be designed to produce as little as 400 Watts or as much as 70 kilowatts. Under normal conditions, the RAT is retracted into the fuselage or wing, deploying automatically in emergency power loss. During the time between power loss and RAT deployment, batteries are used.

International Publication Number WO 2006/094743 A1 discloses a fuel cell system as an emergency power supply for aircraft that operates independent of the aircraft's air speed and mechanical complexity. The fuel cell system includes a fuel cell that is supplied with fuel from a compressed hydrogen gas cylinder and oxidant from a compressed oxygen gas cylinder. This arrangement allows the fuel cell to operate independent of outside air pressures and ensures rapid startup of the fuel cell system.

Upon detecting an undersupply of power or a drop in voltage, a power distribution unit can automatically activate the fuel cell system. Therefore, under normal aircraft operation, the fuel cell system will not consume any of the resources that would be needed during emergency operation. Upon activation, the fuel cell system produces an electrical current that can be used to drive a hydraulic pump or supply electrical power to the power distribution unit. Waste gases arising during operation of the fuel cell system are discarded through a ventilation line.

U.S. Pat. No. 6,296,957 discloses a fuel cell on board an aircraft for use as an energy supply unit that can power various aircraft electrical systems. The fuel cell can replace the main power unit generator, the auxiliary power unit (APU), the Ram Air Turbine (RAT), and battery systems. The fuel cell may operate on hydrogen gas stored in a container and air from outgoing air of the on-board air-conditioning system or by way of an inflow-opening in the airplane shell.

U.S. Publication 2003/0075643 discloses an electrically powered aircraft having fuel cells as at least a partial source of electrical energy. In some instances, the electrical output from the fuel cell is augmented by power from special high power batteries, such as for takeoff and climbing. The fuel cell may be supplied with oxygen from a container of oxygen or from a ram scoop that directs air to the fuel cell.

U.S. Pat. No. 5,810,284 discloses an aircraft consisting of a flying wing with photovoltaic arrays that supply electrical energy to one or more motors. Any excess electricity from the photovoltaic arrays is input to a regenerative fuel cell that generates hydrogen and oxygen gases for storage in separate pressure vessels. During the night, the hydrogen and oxygen gases are supplied to the fuel cell to provide sufficient electrical energy to power the one or more motors and maintain the aircraft in flight.

Fuel cells are a type of electrochemical cell that produces electrical energy as a result of electrochemically combining chemical reactants, commonly referred to as a fuel and an oxidant, within the fuel cells and producing at least one chemical product as well as releasing thermal energy. In a fuel cell, electrical energy is produced due to electrochemical oxidation reactions and electrochemical reduction reactions taking place within the fuel cell. A fuel cell may use hydrogen gas as a fuel (or reductant) along with oxygen gas or air as an oxidant which will be transformed electrochemically within the fuel cell to produce electrical energy along with water so long as the fuel and oxidant are supplied to the fuel cell. The water thus produced is commonly referred to as “product water”.

Other chemical oxidants (besides oxygen or air) and chemical reductants (besides hydrogen) can be used in electrochemical cells. For instance, in the case of fuel cells typical chemical reductants (or fuels) would include methanol, ethanol, formic acid, dimethyl ether, hydrazine, and ammonia, while typical chemical oxidants would include hydrogen peroxide, nitric acid, chlorine, and bromine. However, the most suitable fuel for fuel cells is hydrogen gas, preferably pure hydrogen gas. Suitable sources of pure hydrogen gas include compressed hydrogen gas in high pressure cylinders, hydrogen gas stored within the lattice of suitably contained metal alloys (such as those known in the art as metal hydrides), and hydrogen contained in chemical hydrides, such as sodium borohydride, lithium hydride, calcium hydride, etc. Hydrogen gas can be released from chemical hydrides on carrying out either hydrolysis or thermolysis processes. An advantage of the hydrolysis process is that the hydrogen released from chemical hydrides is humidified as it is produced.

In order to function, a fuel cell comprises two electrodes, typically referred to as an anode and a cathode, separated by an electrolyte. The electrolyte can consist of an ionically conducting aqueous solution, such as, aqueous potassium hydroxide, or aqueous sulfuric acid. However, it is more convenient if the electrolyte is in the form of an ion exchange membrane, either a cation exchange membrane or an anion exchange membrane. Ion exchange membranes can be in the form of thin, flexible organic polymer materials or thin, rigid ceramic materials. Typically, organic polymer cation exchange membrane materials can be homogeneous polymers as represented by the NAFION® product line made by DuPont of Wilmington, Del., or polymer composites comprising a support matrix impregnated with the cation exchange polymer material as represented by the GORE SELECT® line of membranes made by W.L. Gore & Associates of Elkington, Md. Ion exchange polymer membranes used in electrochemical cells typically have thicknesses in the range of 20 to 200 μm. An attractive form of a cation exchange membrane as a solid polymer electrolyte for use in electrochemical cells is a proton (H⁺) exchange membrane (PEM). Similarly, an attractive form of an anion exchange membrane as a solid electrolyte for electrochemical cells includes hydroxyl ion (OH⁻) exchange membranes (HIEM) and oxide ion (O²⁻) exchange membranes (OIEM). As is well known to one skilled in the art, “ion exchange membranes,” “cation exchange membranes,” and “anion exchange membranes” are also referred to as “ion conducting membranes,” “cation conducting membranes” and “anion conducting membranes,” respectively.

In general, thin, flexible organic polymer ion exchange membranes used as solid polymer electrolytes in electrochemical cells are limited to operating temperatures of less than 100° C. at pressures close to atmospheric pressure since ion conduction through these membranes requires that the membranes be at least partially saturated with water in the liquid phase. Thus, in order for NAFION®-like proton exchange membranes to conduct protons from the anode, through the thickness of a proton exchange membrane to the cathode, it is necessary for such membranes to be wet with liquid water. This water has been provided from various sources in the past, including humidification of the anode reactant gas, humidification of the cathode reactant gas, and by back diffusion of liquid water if produced at the cathode, through the proton exchange membrane towards the anode.

During operation of a fuel cell supplied with gaseous reactants, e.g., hydrogen gas as the fuel at the anode and oxygen gas (or air) as the oxidant at the cathode, organic polymer proton exchange membranes can become sufficiently dehydrated either at the anode electrocatalyst/membrane interface, the cathode electrocatalyst/membrane interface, or throughout the bulk thickness of the membrane such that cell performance can be greatly reduced and degradation or decomposition of the membrane takes place. Dehydration of a membrane can occur almost uniformly over the electrochemically active plane of the membrane or in localized regions of the active plane. One mechanism that leads to drying of a proton exchange membrane is referred to as electroosmotic drag. As protons pass from the anode to the cathode through the proton exchange membrane each proton drags water molecules surrounding the proton, or within its hydration sheath, with it towards the cathode. Accordingly, this drying effect occurs throughout operation of a fuel cell that is supplied with gaseous reactants. Furthermore, this drying effect is relatively proportional to the current density experienced by the fuel cell during operation. The dehydrating effects due to this mechanism of drying have the greatest impact on the performance of a fuel cell at the anode electrocatalyst/membrane interface.

A second mechanism of drying a proton exchange membrane solid polymer electrolyte in an electrochemical cell is associated with the characteristics of the anode reactant gas and cathode reactant gas (if any) introduced into the cell. If these reactant gases are not almost fully humidified at the operating temperatures and pressures of the electrochemical cell, the membrane can dry out at either the anode electrocatalyst/membrane interface, the cathode electrocatalyst/membrane interface, or at both electrocatalyst/membrane interfaces. The dehydrating effects as a result of this mechanism will be more pronounced the greater the flow rate of the dry, or partially humidified, reactant gases supplied to the electrochemical cell. Furthermore, membrane drying effects arising from this mechanism will tend to be non-uniform in the plane of the membrane and will be more pronounced at the points of introduction of the reactant gas(es) into the electrochemical cell. Therefore, the extent of drying of a proton exchange membrane in an electrochemical cell depends upon various factors, including the physical design, or structure, of the cell and the operating conditions in which the cell is used.

While the PEM, or at least the anode electrocatalyst/membrane interface, is subject to drying, the cathode electrocatalyst/membrane interface can be the subject of flooding. Flooding is a term used to describe the situation when liquid water covers reaction sites on the electrocatalyst layer, and/or saturates the gas diffusion layer in contact with the electrocatalyst layer, such that most of a reactant gas is blocked from accessing the electrocatalyst sites. The flooding of the cathode in a fuel cell is effected by several factors, including the rate of water generation at the cathode, the rate of electroosmotic water transfer from the anode through the proton exchange membrane to the cathode, and the operating conditions of the fuel cell including temperature, pressure, reactant gas stoichiometry, and the extent of humidification of the reactant gas.

During the operation of PEM fuel cells, it is essential that a proper water balance be maintained between a rate at which water is produced at the cathode electrode and rates at which water is removed from the cathode and at which water is supplied to the anode electrode. An operational limit on performance of a fuel cell is defined by an ability of the cell to maintain the water balance as electrical current drawn from the cell into the external load circuit varies and as an operating environment such as the surrounding temperature of the cell varies. For a PEM fuel cell, if insufficient water is returned to the anode electrode, adjacent portions of the PEM electrolyte dry out thereby decreasing the rate at which protons may be transferred through the PEM and also resulting in cross-over of the reducing fuel gas, which is typically hydrogen or a hydrogen rich gas, leading to local over heating. Thus, drying out or localized loss of water, in particular at a reactant inlet, can ultimately result in the development of cracks and/or holes in a proton exchange membrane. These holes allow the mixing of the hydrogen and oxygen reactants, commonly called “cross over,” with a resultant chemical combustion of cross over reactants, loss of electrochemical energy efficiency, and localized heating. Such localized heating can further promote the loss of water from the proton exchange membrane and further drying out of the membrane, which can accelerate reactant cross over.

Several approaches have been considered for dealing with the problem of removing product water from the active area of a stack of electrochemical cells such as a fuel cell stack. One approach is to evaporate the product water into the oxidant gas stream. This approach has a disadvantage in that it requires that the incoming oxidant gas be almost unsaturated so that the product water (and any water dragged from the anode to the cathode) will evaporate into the unsaturated oxidant gas stream.

In a PEM fuel cell, or in a PEM fuel cell stack, that employs the aforesaid water removal approach, the flow rate of the oxidant gas stream must be sufficiently high to ensure that the oxidant gas stream does not become saturated with water vapor within the flow path across the active area of a cell or cells. Otherwise, saturation of the oxidant gas stream in the flow path across the active area will prevent evaporation of the product water and electroosmotic drag water, such that liquid water will be left at the cathode gas diffusion electrode/flow path interface. A buildup of this liquid water will prevent access of oxidant gas to the active sites of the cathode electrocatalyst, thereby causing an increase in cell polarization, i.e., mass transport polarization, and a decrease in fuel cell performance and efficiency. Another disadvantage with the removal of product and drag water by evaporation through the use of an unsaturated oxidant gas stream is that the proton conducting membrane itself may become dry, particularly at the oxidant gas inlet of a cell.

A second approach for removing product and drag water from the cathode side of fuel cells involves the entrainment of the product and drag water as liquid droplets in the fully saturated flowing oxidant gas stream. This approach requires high flow rates of the oxidant gas stream to sweep the product water off the surface of the cathode electrode area through the flow field. Where air is the oxidant gas stream, these high flow rates require a large air circulation system and may cause a decrease in the utilization of the oxidant, i.e., in the fraction of reactant (oxygen) electrochemically reduced to form water. A decrease in the utilization of the oxidant gas lowers the overall efficiency of the fuel cell and requires a larger capacity pump and/or blower to move the oxidant gas stream through the flow field in order to entrain the product water. At very high current densities, oxidant utilizations as low as 5% may be necessary to remove the product water.

FIG. 1 is a system diagram of a prior art hydrogen-oxygen fuel cell system 10. Like the system disclosed in WO 2006/094743 A1, this system includes a hydrogen-oxygen fuel cell 12 having an anode that receives dry hydrogen gas (fuel) directly from a pressurized hydrogen tank 14 and a cathode that receives dry oxygen gas (oxidant) directly from a pressurized oxygen tank 16. Water accumulating in the cathode is carried out of the cathode by flowing excess oxygen gas through the cathode and venting the water and oxygen. Water and excess hydrogen may be similarly vented from the anode. A cooling system 18 is also provided to remove heat that is generated in the fuel cell.

### BRIEF SUMMARY OF THE INVENTION

One embodiment of the present invention provides a fuel cell emergency power system, comprising a fuel cell having an anode and a cathode, a power distribution unit for selectively directing electrical current from the fuel cell to one or more consuming device, a hydrogen gas control system and an oxygen gas control system. The hydrogen gas control system includes a pressurized hydrogen tank providing hydrogen gas in selective fluid communication to the anode, a hydrogen gas-liquid water phase separator in downstream fluid communication with the anode, and a hydrogen gas recirculation pump for recirculating substantially liquid water-free hydrogen gas from the hydrogen gas-liquid water phase separator to the anode. Similarly, the oxygen gas control system includes a pressurized oxygen tank providing oxygen gas in selective fluid communication to the anode, an oxygen gas-liquid water phase separator in downstream fluid communication with the anode, and an oxygen gas recirculation pump for recirculating substantially liquid water-free oxygen gas from the oxygen gas-liquid water phase separator to the anode.

In another embodiment, the emergency power system includes a regenerative fuel cell having a cathode in selective fluid communication with a water reservoir, and wherein the power distribution unit is electronically connected to a primary source of electrical current for selectively applying electrical current to the regenerative fuel cell to generate hydrogen gas at the anode and increase the amount of hydrogen gas in the pressurized hydrogen tank. Alternatively, the emergency power system includes both a fuel cell and an electrolyzer in fluid communication with a water reservoir and electronically connected to the power distribution unit, wherein the power distribution unit is coupled to a primary source of electrical current for selectively applying electrical current to the electrolyzer to generate hydrogen gas at the cathode and increase the amount of hydrogen gas in the pressurized hydrogen tank.

Yet another embodiment of the invention provides a method of operating a fuel cell emergency power system. The method comprises monitoring a power distribution unit for an emergency power condition, monitoring the hydrogen gas pressure in a hydrogen gas tank, electrolyzing water to produce hydrogen gas and oxygen gas in response to detecting a hydrogen gas pressure less than a setpoint pressure while there is no emergency power condition, and adding the produced hydrogen gas to the hydrogen gas tank to maintain the desired quantity of hydrogen gas in the hydrogen gas tank.

A further embodiment provides a fuel cell system comprising a hydrogen-oxygen fuel cell having at least one anode in fluid communication with a source of hydrogen gas and at least one cathode with an outlet port and an inlet port in fluid communication with a source of oxygen gas. The fuel cell system further comprises a first conduit providing fluid communication between the at least one cathode outlet port and a closed vessel for gravity separation of a cathode outlet stream containing a liquid fraction and a gas fraction, a second conduit in fluid communication with the closed vessel adjacent an inside wall of the closed vessel, wherein the second conduit includes a control valve for controlling the discharge of liquid from the closed vessel, and a third conduit extending into the closed vessel and having a liquid-resistant, gas port in a central region of the closed vessel for removal of the gas fraction.

A still further embodiment provides a gas-liquid separator comprising a closed vessel for gravity separation of gases and liquids. A first conduit is in fluid communication with the closed vessel, wherein the first conduit delivers a fluid stream containing a liquid fraction and a gas fraction. A second conduit is in fluid communication with the closed vessel at a position along an inside wall of the closed vessel, wherein the second conduit includes a control valve for controlling the discharge of liquid from the closed vessel. A third conduit extends into the closed vessel and has a liquid-resistant, gas port in a central region of the closed vessel for withdrawal of the gas fraction. For example, the liquid-resistant gas port may include a shield that resists entry of the liquid splashing into the gas port under turbulent conditions.

An additional embodiment provides a method for separating gas and liquid under turbulent conditions. The method comprises introducing a fluid stream into a closed vessel, wherein the fluid stream contains a liquid fraction and a gas fraction. The liquid fraction is accumulated along an inner surface of the closed vessel and the accumulated liquid is discharged from the inner surface of the closed vessel through a liquid outlet port in the wall of the closed vessel. The gas fraction is removed from a central region of the closed vessel through a port in a gas outlet conduit, and the gas outlet port is shielded to resist liquid entry into the gas outlet conduit as a result of liquid splashing under the turbulent conditions.

### BRIEF DESCRIPTION OF THE SEVERAL VIEWS OF THE DRAWINGS

FIG. 1 is a system diagram of a prior art hydrogen-oxygen fuel cell system.

FIG. 2 is a system diagram of a hydrogen-oxygen fuel cell system of the present invention with a hydrogen recirculation system and an oxygen recirculation system.

FIG. 3 is a system diagram of a regenerative hydrogen-oxygen fuel cell system of the present invention.

FIG. 4 is a schematic cross-sectional view of a first embodiment of a liquid-gas phase separator that is tolerant of highly turbulent conditions.

FIG. 5 is a schematic cross-sectional view of a second embodiment of a liquid-gas phase separator that is tolerant of highly turbulent conditions.

FIG. 6 is a schematic cross-sectional view of a third embodiment of a liquid-gas phase separator that is tolerant of highly turbulent conditions.

FIG. 7 is a schematic cross-sectional view of a fourth embodiment of a liquid-gas phase separator that is tolerant of highly turbulent conditions.

FIG. 8 is a schematic cross-sectional view of a fifth embodiment of a liquid-gas phase separator that is tolerant of highly turbulent conditions.

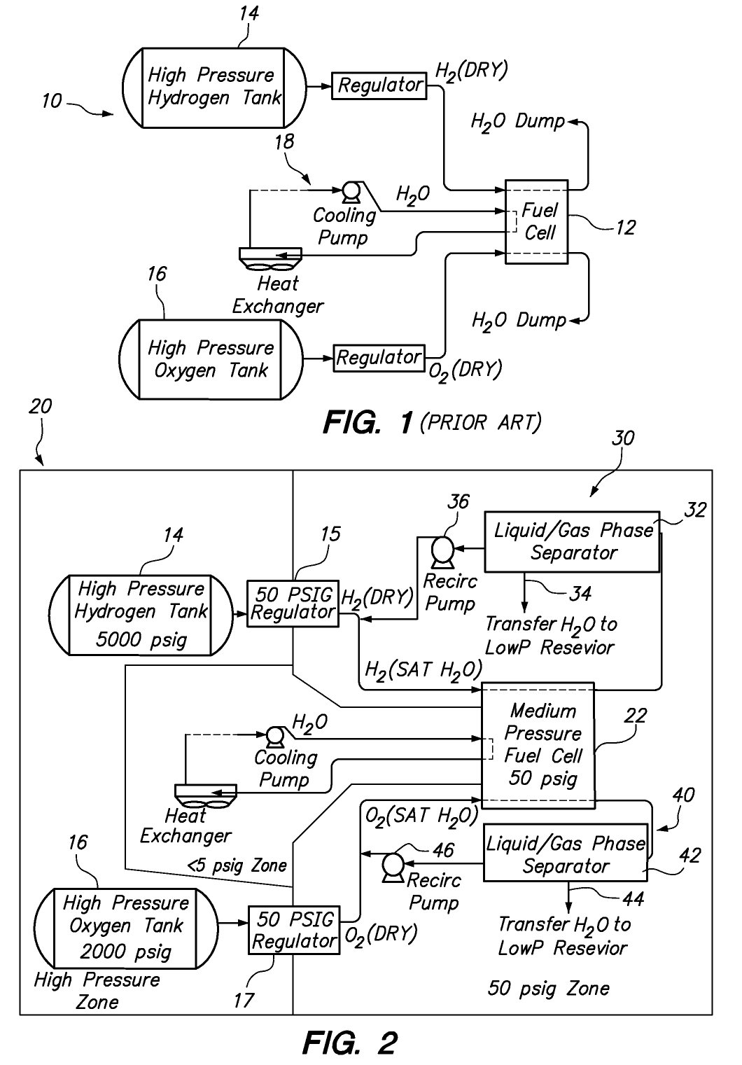

### DETAILED DESCRIPTION OF THE INVENTION

One embodiment of the present invention provides a fuel cell emergency power system, comprising a fuel cell stack having a plurality of anodes and cathodes, a power distribution unit for selectively directing electrical current from the fuel cell stack to one or more consuming device, a hydrogen gas control system and an oxygen gas control system. The fuel cell emergency power system may be implemented in many applications where backup power systems are used, including residential and commercial buildings, hospitals, automobiles, boats, and aircraft. It should be recognized that the fuel cell stack will include a variable number and size of anodes and cathodes in order to meet the electrical requirements of the specific application and installation. For example, increasing the number of anode and cathodes arranges electronically in series will increase the voltage output of the fuel cell stack, and increasing the area of the anodes and cathodes will increase the current output of the fuel cell stack. The embodiments of the present invention may be implemented using hydrogen-oxygen fuel cell stacks of any beneficial size or configuration.

The hydrogen gas control system includes a pressurized hydrogen tank providing hydrogen gas in selective fluid communication to the anode, a hydrogen gas-liquid water phase separator in downstream fluid communication with the anode, and a hydrogen recirculation pump for recirculating substantially liquid water-free hydrogen from the hydrogen gas-liquid water phase separator to the anode. Similarly, the oxygen gas control system includes a pressurized oxygen tank providing oxygen gas in selective fluid communication to the anode, an oxygen gas-liquid water phase separator in downstream fluid communication with the anode, and an oxygen recirculation pump for recirculating substantially liquid water-free oxygen from the oxygen gas-liquid water phase separator to the anode. Using pressurized sources of hydrogen gas (fuel) and oxygen gas (oxidant) enable the fuel cell to startup without requiring any power, as would be necessary to operate a fan or compressor when using ambient air as the oxidant. Furthermore, the pressurized sources provide an immediate supply of hydrogen and oxygen to the fuel cell to prevent delays in the startup, as would occur if the hydrogen had to be obtained from a hydrocarbon source. Still further, when the hydrogen or oxygen gases have no significant concentrations of carrier gases or impurities, little or none of the gases has to be discarded and the recirculation of the gases through the fuel cell stack can be controlled to optimize water management within the fuel cell stack.

In a preferred configuration, the fuel cell emergency power system further includes a hydrogen pressure or flow control valve for controlling the pressure or flow rate of hydrogen gas into the anode, and an oxygen pressure or flow control valve for controlling the pressure or flow rate of oxygen gas into the cathode. For simplicity of the system, the gases may be supplied to the fuel cell stack at a constant pressure. The fuel cell stack will consume more or less hydrogen and oxygen as needed to follow the electronic load of the power consuming devices. It should also be recognized that the gas supply pressure to the fuel cell stack can be selected and controlled independent of the gas recirculation rate.

The fuel cell emergency power system may further comprise a controller in control communication with the hydrogen recirculation pump for controlling the rate of hydrogen recirculation to the anode and in control communication with the oxygen recirculation pump for controlling the rate of oxygen recirculation to the cathode. The rate or recirculation may be controlled in proportion to the electronic load placed on the fuel cell stack, which is itself proportional to the rate of hydrogen and oxygen gas consumption and product water generation. Recirculation of the gases, particularly the recirculation of the oxygen gas, helps remove product water that can otherwise accumulate and flood the cathode. Flooding in the cathode reduces or prevents oxygen diffusion to the surface of the cathode. In the absence of a continuous and adequate supply of oxygen at the cathode surface, the electrical output of the fuel cell stack can decline or stop.

The hydrogen gas-liquid water phase separator preferably includes a liquid level detector, a liquid discharge conduit, and a valve disposed in the liquid discharge conduit, wherein the valve discharges liquid from the hydrogen gas-liquid water phase separator upon activation of the liquid level detector. The liquid level detector may provide an electrical signal to the liquid discharge valve that opens the valve to discharge liquid from the separator. Optionally, the separator may include a high level detector to initial liquid discharge and a low level detector to terminate liquid discharge. The liquid discharge valve is operated to limit to the amount of water accumulating in the separator and reduce or prevent water from getting into the gas recirculation conduit. If the liquid is being discharged into a separate water reservoir, then there is no particular need to maintain any significant amount of water in the separator except that it is desirable to prevent gases from discharging with the water.

The oxygen gas-liquid water phase separator preferably includes a liquid level detector, a liquid discharge conduit, and a valve disposed in the liquid discharge conduit, wherein the valve discharges liquid from the oxygen gas-liquid water phase separator upon activation of the liquid level detector. The design and operation of the oxygen gas-liquid water phase separator is similar to that of the hydrogen gas-liquid water phase separator described above. However, the cathode is generally more subject to flooding due to the electroosmotic flow of water from the anode to the cathode and the product water being generated at the cathode. Therefore, the presence and operation of the oxygen gas-liquid water phase separator is frequently more critical than the presence and operation of the hydrogen gas-liquid water phase separator. For this reason, the oxygen gas-liquid water phase separator may be larger.

In another embodiment, the fuel cell emergency power system includes a regenerative fuel cell having a cathode is selective fluid communication with a water reservoir, and wherein the power distribution unit is electronically connected to a primary source of electrical current for selectively applying electrical current to the regenerative fuel cell to generate hydrogen gas at the anode and increase the amount of hydrogen gas in the pressurized hydrogen tank. Alternatively, the emergency power system includes both a fuel cell and an electrolyzer in fluid communication with a water reservoir and electronically connected to the power distribution unit, wherein the power distribution unit is coupled to a primary source of electrical current for selectively applying electrical current to the electrolyzer to generate hydrogen gas at the cathode and increase the amount of hydrogen gas in the pressurized hydrogen tank. The selective application of electrical current to either the electrolyzer should be limited to periods of time when the power distribution unit has electrical power available (i.e., no emergency power condition). Typically, the fuel cell stack and the electrolyzer should not be in operation simultaneously, except perhaps in a system testing mode. The nature of a regenerative fuel cell utilizes the same structure for the generation of electricity (fuel cell mode) and the generation of hydrogen and oxygen (electrolyzer mode), such that the two modes are mutually exclusive.

Optionally, the water reservoir receives water discharged by the hydrogen gas-liquid water phase separator and/or water discharged by the oxygen gas-liquid water phase separator. This water can be used by a regenerative fuel cell stack, an electrolyzer, or other unrelated manners associated with the particular application, such as in the lavatory of an aircraft in which the fuel cell emergency power system is installed. However, the water is preferably used to maintain the supply of hydrogen and oxygen gases available to the fuel cell stack. In a further option, the hydrogen and oxygen are used to generate electricity and water during an emergency power condition, then the water is used to replenish the hydrogen and oxygen supplies when electrical energy is again available in sufficient amounts (i.e., when the emergency power condition has passed).

In another embodiment, the fuel cell emergency power system includes a pressure sensor disposed to measure the hydrogen gas pressure in the pressurized hydrogen gas tank and a controller in electronic communication with the pressure sensor and the power distribution unit. Accordingly, the controller will cause the electrolyzer to generate hydrogen gas in response to the pressure sensor measuring a hydrogen gas pressure below a predetermined setpoint during a time period that the power distribution unit is not directing electrical current from the fuel cell to one or more consuming device.

Yet another embodiment of the invention provides a method of operating a fuel cell emergency power system. The method comprises monitoring a power distribution unit for an emergency power condition, monitoring the hydrogen gas pressure in a hydrogen gas tank, electrolyzing water to produce hydrogen gas and oxygen gas in response to a hydrogen gas pressure less than a setpoint pressure while there is no emergency power condition, and adding the produced hydrogen gas to the hydrogen gas tank to maintain the desired quantity of hydrogen gas in the hydrogen gas tank. Preferably, the oxygen gas produced by the electrolysis is added to the oxygen gas tank.

The method may further include controllably providing hydrogen gas to the fuel cell during an emergency condition, wherein the step of providing hydrogen gas includes supplying hydrogen gas from the hydrogen gas tank to a fuel cell, recirculating hydrogen gas through the fuel cell, and phase separating water from the recirculating hydrogen gas before returning the hydrogen gas to the fuel cell. Because the hydrogen and oxygen gases from the pressurized tanks are probably dry, the recirculation of one or more of the gases provides water vapor to the gas inlet to the fuel cell stack. Although the phase separators will remove liquid water from the recirculating gases, the gases will retain water vapor that is recirculated back to the fuel cell stack. Therefore, after a short initial period of operating the fuel cell stack, the gas input to the stack is a combination of potentially dry gas from the gas tank and humidified gas being recirculated. The rate of recirculation effects not only the removal of liquid water from the stack, but also the degree of humidification at the gas inlet to the stack.

Further still, the method may include supplying oxygen gas from an oxygen gas tank to a fuel cell, recirculating oxygen gas through the fuel cell, and phase separating water from the recirculating oxygen gas before returning the oxygen gas to the fuel cell. Optionally, the method may then include collecting water from the phase separation, and providing the collected water for use in the step of electrolyzing.

A further embodiment provides a fuel cell system comprising a hydrogen-oxygen fuel cell having at least one anode in fluid communication with a source of hydrogen gas and at least one cathode with an outlet port and an inlet port in fluid communication with a source of oxygen gas. The fuel cell system further comprises a first conduit providing fluid communication between the at least one cathode outlet port and a closed vessel for gravity separation of a cathode outlet stream containing a liquid fraction and a gas fraction, a second conduit in fluid communication with the closed vessel adjacent an inside wall of the closed vessel, wherein the second conduit includes a control valve for controlling the discharge of liquid from the closed vessel, and a third conduit extending into the closed vessel and having a liquid-resistant, gas port in a central region of the closed vessel for removal of the gas fraction.

A still further embodiment provides a gas-liquid separator comprising a closed vessel for gravity separation of gases and liquids. A first conduit is in fluid communication with the closed vessel, wherein the first conduit delivers a fluid stream containing a liquid fraction and a gas fraction. A second conduit is in fluid communication with the closed vessel at a position along an inside wall of the closed vessel, wherein the second conduit includes a control valve for controlling the discharge of liquid. A third conduit extends into the closed vessel and has a liquid-resistant gas port in a central region of the closed vessel for withdrawal of the gas fraction. For example, the liquid-resistant gas port may include a shield that resists entry of the liquid splashing into the gas port under turbulent conditions.

The liquid-resistant gas port is configured to prevent or reduce the entry of water into the conduit exiting the phase separator with gas being recirculating back to the fuel cell stack. For example, the liquid-resistant gas port may include one or more baffles shielding the port into this conduit. The one or more baffles serve to deflect splashing liquid from getting into the port and redirect any liquid away from the port. Alternatively, the port may be covered with a porous, hydrophobic material. In a further embodiment, the inside surface of the walls of the closed vessel is hydrophilic, such as provided by a coating of a hydrophilic material applied to the inside surface.

A preferred closed vessel or separator includes a liquid level sensor disposed to detect the liquid level in the vessel, and a controller for opening the control valve to discharge liquid in response to the liquid level exceeding a predetermined liquid level. One preferred configuration of the closed vessel is substantially spherical, wherein the predetermined liquid level is less than the shortest distance between the gas port and the wall of the closed vessel. In this manner, a change in the orientation of the vessel will not result in the gas port becoming submerged or flooded, or an increase the potential for splashing liquid to enter the gas port. Another preferred configuration includes an impingement plate disposed in the closed vessel in alignment with the first conduit. The impingement plate redirects liquid water entering the separator vessel away from the gas port. Optionally, a shield may be disposed substantially across the closed vessel just above the predetermined water level when the closed vessel is in a normal orientation. This shield can deflect water away from the gas port during a sudden change in the orientation or movement of the vessel, such as can be experienced during turbulent conditions aboard an aircraft.

An additional embodiment provides a method for separating gas and liquid under turbulent conditions. The method comprises introducing a fluid stream into a closed vessel, wherein the fluid stream contains a liquid fraction and a gas fraction. The liquid fraction is accumulated along an inner surface of the closed vessel and the accumulated liquid is discharged from the inner surface of the closed vessel through a liquid outlet port in the wall of the closed vessel. The gas fraction is removed from a central region of the closed vessel through a port in a gas outlet conduit, and the gas outlet port is shielded to resist liquid entry into the gas outlet conduit as a result of liquid splashing under the turbulent conditions. In a fuel cell emergency power system, the fluid stream is the outlet from at least one cathode (for an oxygen gas-liquid water phase separator) or at least one anode (for hydrogen gas-liquid water phase separator) of a hydrogen-oxygen fuel cell.

The method for separating gas and liquid under turbulent conditions may further include detecting accumulated liquid adjacent the liquid outlet port and controlling the amount of accumulated liquid being discharged through the liquid outlet port. In a further option, the method may include initiating discharge of accumulated liquid upon detecting a high liquid level and terminating discharge of accumulated liquid upon detecting a low liquid level. In a still further option, the closed vessel includes a plurality of liquid outlet ports, and accumulated liquid is discharged through one of the plurality of liquid outlet ports where accumulated liquid is detected.

FIG. 2 is a system diagram of a hydrogen-oxygen fuel cell system 20 of the present invention with a hydrogen recirculation system 30 and an oxygen recirculation system 40. A pressurized hydrogen gas tank 14 provides hydrogen gas through a pressure regulator 15 to the anode side of a fuel cell stack 22. Some of the hydrogen gas is consumed over an anodic electrocatalyst to support the production of electrical current and some of the hydrogen gas passes through anode flow fields to push liquid water, if any, out of the anode chamber. As the hydrogen gas passes through the flow fields, the hydrogen gas becomes humidified. The hydrogen recirculation system 30 causes the humidified hydrogen gas and liquid water flow into a gas-liquid (hydrogen-water) phase separator 32 that directs the liquid water to a drain line 34 and directs the humidified hydrogen gas to a recirculation pump 36. In this manner, the humidified hydrogen gas returns to the anode to keep the anode side of the proton exchange membrane (PEM) moist to support proton conductivity.

A pressurized oxygen gas tank 16 provides hydrogen gas through a pressure regulator 17 to the cathode side of the fuel cell stack 22. Some of the oxygen gas is consumed over a cathodic electrocatalyst to support the production of electrical current and some of the oxygen gas passes through cathode flow fields to push liquid water, if any, out of the cathode chamber. As the oxygen gas passes through the flow fields, the oxygen gas becomes humidified. The oxygen recirculation system 40 causes the humidified oxygen gas and liquid water flow into a gas-liquid (oxygen-water) phase separator 42 that directs the liquid water to a drain line 44 and directs the humidified oxygen gas to a recirculation pump 46. In this manner, the humidified oxygen gas returns to the cathode to keep the cathode side of the proton exchange membrane (PEM) moist to support proton conductivity.

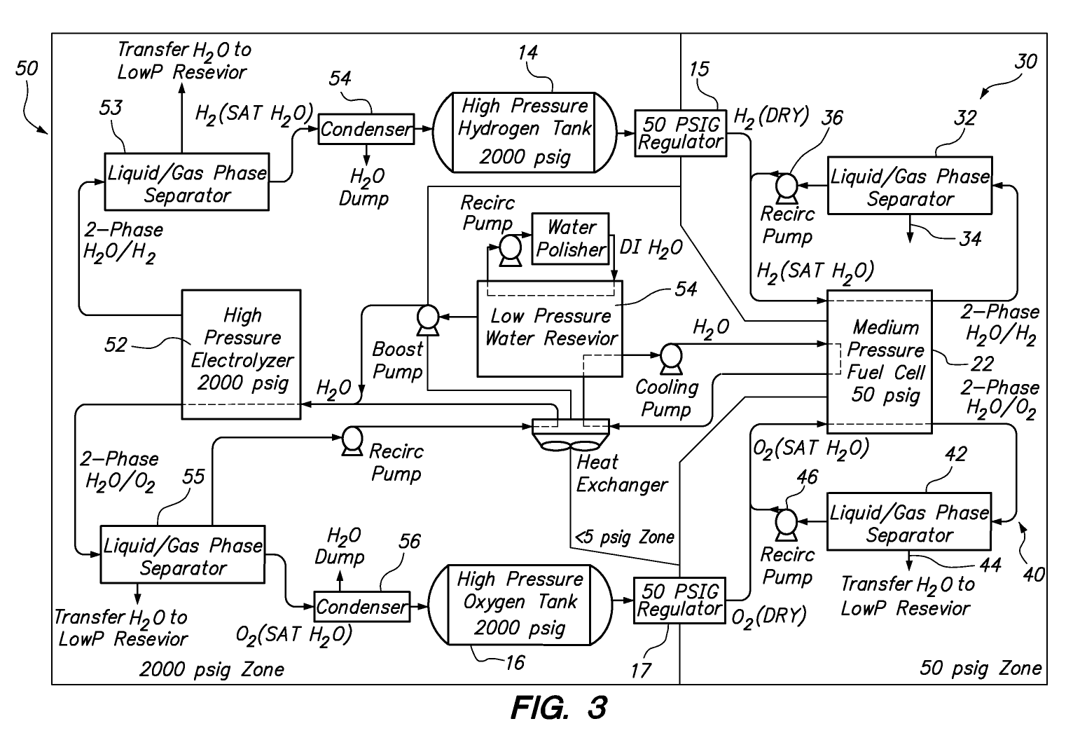

FIG. 3 is a system diagram of a regenerative hydrogen-oxygen fuel cell system 50 of the present invention. Like system 20 of FIG. 2, the regenerative system 50 includes the hydrogen-oxygen fuel cell 22, hydrogen tank 14, hydrogen gas recirculation system 30, oxygen tank 16, and oxygen gas recirculation system 40. However, the regenerative system 50 includes an electrolyzer 52 that can be driven by an applied electrical current from the power distribution unit to electrolyze water drawn from the water reservoir 54. The electrolysis of water in the electrolyzer 52 produces hydrogen gas that is supplied to the hydrogen tank 14 through a phase separator 53 and a condenser 54. The phase separator 53 removes any liquid water from the hydrogen stream and the condenser 54 cools the gas to cause the condensation of water vapor. Accordingly, the hydrogen gas provided to the tank 14 is substantially de-humidified and may be considered to be dry hydrogen gas.

The electrolysis of water in the electrolyzer 52 also produces oxygen gas that is supplied to the oxygen tank 16 through a phase separator 55 and a condenser 56. The phase separator 55 removes any liquid water from the oxygen stream and the condenser 56 cools the gas to cause the condensation of water vapor. Accordingly, the oxygen gas provided to the tank 16 is substantially de-humidified and may be considered to be dry oxygen gas.

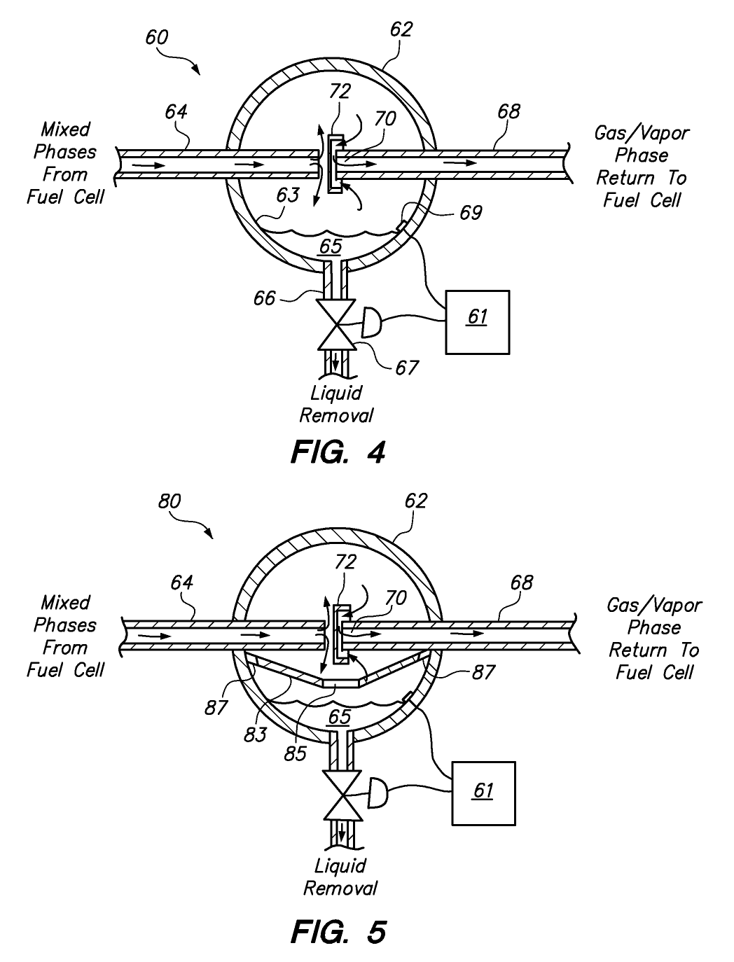

FIG. 4 is a schematic cross-sectional view of a first embodiment of a liquid-gas phase separator 60 that is tolerant of highly turbulent conditions. The construction of the separator 60 may be used for any or all of the liquid-gas phase separators 32, 42, 53, 55 of FIGS. 2-3. However, the separators shown in FIGS. 4-8 will be described in terms of the oxygen-water separator 42 in the oxygen recirculation system 40 associated with the fuel cell 22. Still, it should be recognized that each of the separators having a mixed phase inlet conduit, a liquid outlet conduit, and a gas phase outlet conduit.

The gas phase separator 60 includes a closed, spherical vessel 62 where gas and liquid are allowed to separate. A first conduit 64 provides fluid communication from the cathodes of the fuel cell stack to the vessel 62 for gravity separation of a cathode outlet stream containing a liquid fraction and a gas fraction. A second conduit 66 provides fluid communication with the closed vessel 62 adjacent an inside wall 63 of the closed vessel, wherein the second conduit includes a control valve 67 for controlling the discharge of liquid from the closed vessel. A third conduit 68 extends into the closed vessel 62 and has a liquid-resistant, gas port 70 in a central region of the closed vessel 62 for removal of the gas fraction.

The gas port 70 draws the gas fraction out of the vessel from a point at or near the center point of the spherical vessel 62. In this manner, turbulent conditions and/or changes in vessel orientation will not cause the accumulated liquid 65 to flood the gas port 70. A shield 72 is disposed over the port 70 to reduce or prevent splashing liquid to enter the port 70, yet allow for gas to enter the port.

The second conduit 66 enables the discharge of the accumulated liquid 65 from the inside surface 63 of the vessel 62. As shown, a liquid level detector 69 is positioned to detect the accumulation of liquid in the vessel. The detector 69 may communicate with a controller 61, which can cause the discharge valve 67 to open and discharge a desired amount of liquid from the vessel. Various schemes for detecting and controlling liquid levels may be implemented.

FIG. 5 is a schematic cross-sectional view of a second embodiment of a liquid-gas phase separator 80 that is tolerant of highly turbulent conditions. The separator 80 is substantially similar to the separator 60 of FIG. 4, except for the addition of a baffle plate 83. The baffle plate 83 has a slight frustoconical shape (i.e., somewhat funnel-shaped) with a central opening 85 that allows water to fall through when the vessel 62 is oriented upright as shown in FIG. 5. A series of holes or gaps 87 are also provided through the baffle plate 83 around the perimeter of the plate, which gaps direct the accumulated water 65 around the side of the vessel 62 should be vessel become inverted.

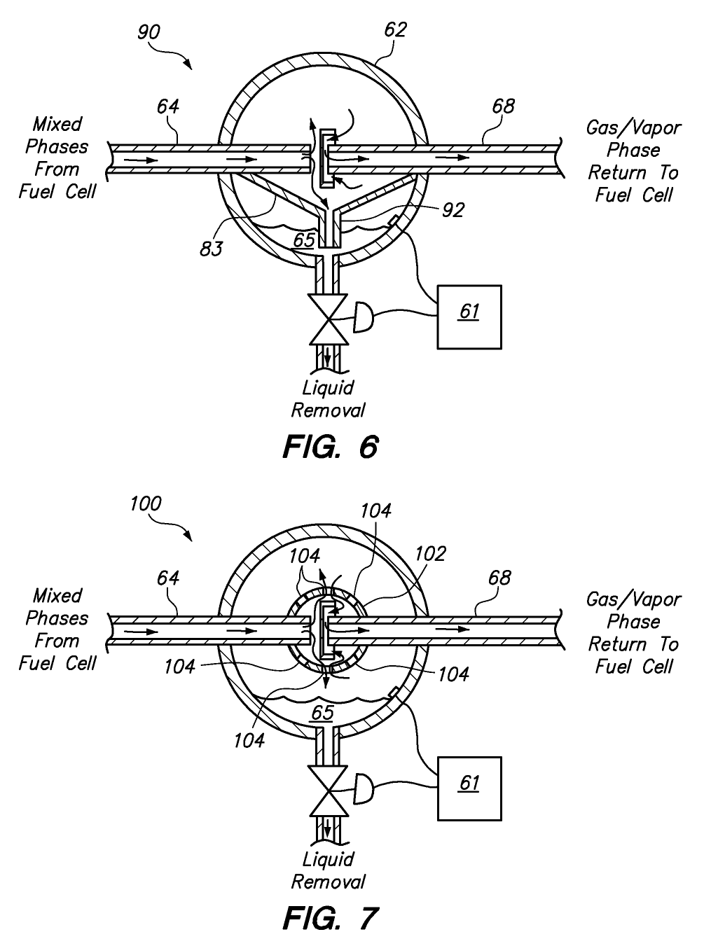

FIG. 6 is a schematic cross-sectional view of a third embodiment of a liquid-gas phase separator 90 that is tolerant of highly turbulent conditions. The separator 90 is substantially similar to the separator 80 of FIG. 5, except for the addition of a dip tube 92 at the central opening 85 of the baffle plate 83. The dip tube 92 reduces the amount of the accumulated water 65 that can flow directly toward the gas port 70 upon inversion of the vessel 62. Furthermore, the dip tube may provide an ideal location for a liquid level sensor.

FIG. 7 is a schematic cross-sectional view of a fourth embodiment of a liquid-gas phase separator 100 that is tolerant of highly turbulent conditions. The separator 100 is substantially similar to the separator 60 of FIG. 4, except for the addition of an inner spherical shield 102 that encompasses the gas port 70 and the end of the first conduit 64. The inner spherical shield 102 includes a plurality of holes 104 to allow gas and liquid to enter and exit the spherical shield 102, yet prevent a large volume of the accumulated liquid 65 from temporarily flooding the gas port 70 due to a sudden inversion of the vessel 62.

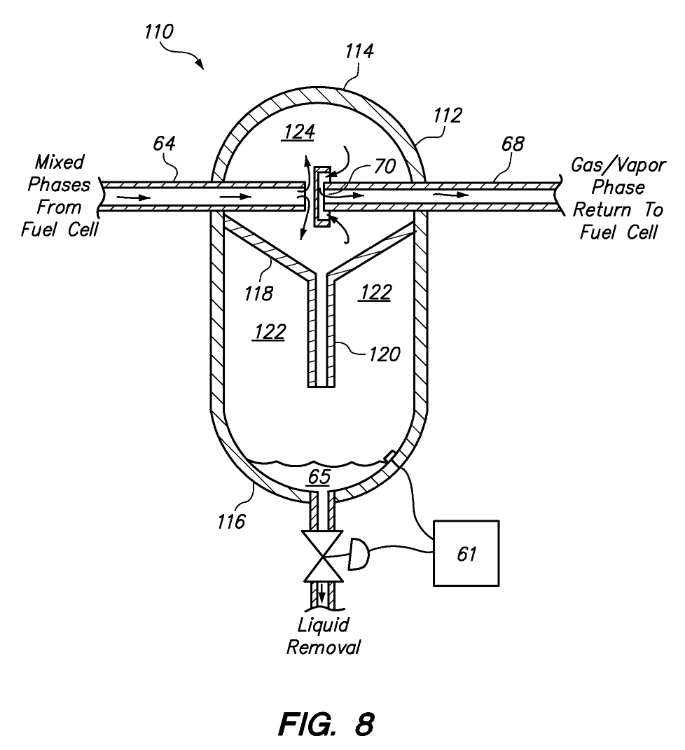

FIG. 8 is a schematic cross-sectional view of a fifth embodiment of a liquid-gas phase separator 110 that is tolerant of highly turbulent conditions. The separator 110 includes an elongate vessel 112 having rounded heads 114, 116. The internal configuration of the vessel 112 may include any of the shields or baffles of FIGS. 4-7, but is shown with a baffle plate 118 and a dip tube 120. The upright length of the vessel 112 allows a larger accumulation of liquid 65 before the liquid could flood the gas port 70. Furthermore, the baffle plate 118 does not include perimeter holes (as holes 87 of FIG. 5), so that inversion of the vessel, either gradual or sudden inversion or turbulence, will trap the water in the annular volume (shaded space 122) rather than allow the water into the space 124 surrounding the gas port 70.

As will be appreciated by one skilled in the art, various embodiments of the present invention may be embodied as systems, methods or computer program products. Accordingly, embodiments of the present invention may include hardware and/or software aspects (including firmware, resident software, micro-code, etc.) that may all generally be referred to herein as a “circuit,” “module” or “system.” Furthermore, aspects of the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be understood that each step of the foregoing methods can be implemented or initiated by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A fuel cell emergency power system, comprising:
a fuel cell having an anode and a cathode;
a power distribution unit for selectively directing electrical current from the fuel cell to one or more consuming devices, wherein the fuel cell is inactive during normal conditions, and wherein the power distribution unit activates the fuel cell in response to detecting an undersupply of electrical power to the one or more consuming devices;
a hydrogen gas control system including a pressurized hydrogen tank providing hydrogen gas in selective fluid communication to the anode, a hydrogen gas-liquid water phase separator in downstream fluid communication with the anode, and a hydrogen recirculation pump for recirculating substantially liquid water-free hydrogen from the hydrogen gas-liquid water phase separator to the anode; and
an oxygen gas control system including a pressurized oxygen tank providing oxygen gas in selective fluid communication to the cathode, an oxygen gas-liquid water phase separator in downstream fluid communication with the cathode, and an oxygen gas recirculation pump for recirculating substantially liquid water-free oxygen from the oxygen gas-liquid water phase separator to the cathode.

2. The system of claim 1, further comprising:
a hydrogen pressure or flow control valve for controlling the pressure or flow rate of hydrogen gas into the anode; and
an oxygen pressure or flow control valve for controlling the pressure or flow rate of oxygen gas into the cathode.

3. The system of claim 2, further comprising:
a controller in control communication with the hydrogen recirculation pump for controlling the rate of hydrogen recirculation to the anode and in control communication with the oxygen recirculation pump for controlling the rate of oxygen recirculation to the cathode.

4. The system of claim 3, wherein the hydrogen gas-liquid water phase separator includes a liquid level detector, a liquid discharge conduit, and a valve disposed in the liquid discharge conduit, wherein the valve discharges liquid from the hydrogen gas-liquid water phase separator upon activation of the liquid level detector.

5. The system of claim 3, wherein the oxygen gas-liquid water phase separator includes a liquid level detector, a liquid discharge conduit, and a valve disposed in the liquid discharge conduit, wherein the valve discharges liquid from the oxygen -liquid phase separator upon activation of the liquid level detector.

6. The system of claim 1, wherein the fuel cell is a unitized regenerative fuel cell having a cathode in selective fluid communication with a water reservoir, and wherein the power distribution unit is electronically connected to a primary source of electrical current for selectively applying electrical current to the regenerative fuel cell to generate hydrogen gas at the cathode and increase the amount of hydrogen gas in the pressurized hydrogen tank.

7. The system of claim 6, wherein the selective application of electrical current to the regenerative fuel cell further generates oxygen gas at the anode.

8. The system of claim 7, wherein the generation of oxygen gas at the anode increases the amount of oxygen gas in the pressurized oxygen tank.

9. The system of claim 6, wherein the water reservoir receives water discharged by the hydrogen gas-liquid water phase separator.

10. The system of claim 1, further comprising:
an electrolyzer in fluid communication with a water reservoir and electronically connected to the power distribution unit, wherein the power distribution unit is coupled to a primary source of electrical current for selectively applying electrical current to the electrolyzer to generate hydrogen gas at the cathode and increase the amount of hydrogen gas in the pressurized hydrogen tank.

11. The system of claim 10, wherein the water reservoir receives water discharged by the hydrogen gas-liquid water phase separator.

12. The system of claim 10, further comprising:
a pressure sensor disposed to measure the hydrogen gas pressure in the pressurized hydrogen gas tank; and
a controller in electronic communication with the pressure sensor and the power distribution unit to cause the electrolyzer to generate hydrogen gas in response to the pressure sensor measuring a hydrogen gas pressure below a predetermined setpoint during a time period that the power distribution unit is not directing electrical current from the fuel cell to one or more consuming device.

13. A method of operating a fuel cell emergency power system, comprising:
monitoring a power distribution unit for an emergency power condition;
monitoring the hydrogen gas pressure in a hydrogen gas tank;
electrolyzing water to produce hydrogen gas and oxygen gas in response to a hydrogen gas pressure less than a setpoint pressure while there is no emergency power condition; and
adding the produced hydrogen gas to the hydrogen gas tank to maintain the desired quantity of hydrogen gas in the hydrogen gas tank.

14. The method of claim 13, further comprising:
adding the oxygen gas to an oxygen gas tank.

15. The method of claim 13, further comprising:
controllably providing hydrogen gas to the fuel cell during an emergency condition, wherein the step of providing hydrogen gas includes supplying hydrogen gas from the hydrogen gas tank to a fuel cell, recirculating hydrogen gas through the fuel cell, and phase separating water from the recirculating hydrogen gas before returning the hydrogen gas to the fuel cell.

16. The method of claim 15, further comprising:
supplying oxygen gas from and oxygen gas tank to a fuel cell;
recirculating oxygen gas through the fuel cell; and
phase separating water from the recirculating oxygen gas before returning the oxygen gas to the fuel cell.

17. The method of claim 15, further comprising:
collecting water from the phase separation; and
providing the collected water for use in the step of electrolyzing.

18. A fuel cell system comprising:
a hydrogen-oxygen fuel cell having at least one anode in fluid communication with a source of hydrogen gas and at least one cathode with an outlet port and an inlet port in fluid communication with a source of oxygen gas;
a first conduit providing fluid communication between the at least one cathode outlet port and a closed vessel for gravity separation of a cathode outlet stream containing a liquid fraction and a gas fraction;
a second conduit in fluid communication with the closed vessel adjacent an inside wall of the closed vessel, wherein the second conduit includes a control valve for controlling the discharge of liquid from the closed vessel; and
a third conduit extending into the closed vessel and having a liquid-resistant, gas port in a central region of the closed vessel for removal of the gas fraction.

19. The fuel cell system of claim 18, wherein the liquid-resistant gas port includes one or more baffles shielding the port.

20. The fuel cell system of claim 18, wherein the liquid-resistant gas port is covered with a porous, hydrophobic material.

21. The fuel cell system of claim 18, further comprising:
a liquid level sensor disposed to detect the liquid level in the closed vessel; and
a controller for opening the control valve in response to the liquid level exceeding a predetermined liquid level.

22. The fuel cell system of claim 21, wherein the closed vessel is substantially spherical, and wherein the predetermined liquid level is less than the shortest distance between the gas port and the wall of the closed vessel.

23. The fuel cell system of claim 22, whereby maintaining the liquid level below the predetermined liquid level prevents the gas port from flooding as a result of a change in the orientation of the closed vessel.

24. The fuel cell system of claim 18, further comprising:
an impingement plate disposed in the closed vessel in alignment with the first conduit.

25. The fuel cell system of claim 18, further comprising:
a shield disposed substantially across the closed vessel just above the predetermined water level when the closed vessel is in a normal orientation.

26. The fuel cell system of claim 18, further comprising:
an electrolyzer having a cathode in fluid communication with the liquid removed through the second conduit; wherein the electrolyzer converts the liquid into hydrogen gas and oxygen gas for use in the fuel cell.

27. A gas-liquid separator comprising:
a closed vessel for gravity separation of gases and liquids;
a first conduit in fluid communication with the closed vessel, wherein the first conduit delivers a fluid stream containing a liquid fraction and a gas fraction;
a second conduit in fluid communication with the closed vessel at a position along an inside wall of the closed vessel, wherein the second conduit includes a control valve for controlling the discharge of liquid; and
a third conduit extending into the closed vessel and having a liquid-resistant, gas port in a central region of the closed vessel for withdrawal of the gas fraction.

28. The gas-liquid separator of claim 27, wherein the liquid-resistant gas port includes a shield that resists entry of the liquid splashing into the gas port under turbulent conditions.

29. The gas-liquid separator of claim 27, wherein the liquid-resistant gas port is covered with a porous, hydrophobic material.

30. The gas-liquid separator of claim 27, further comprising:
a liquid level sensor disposed to detect the liquid level in the closed vessel; and
a controller for opening the control valve in response to the liquid level exceeding a predetermined liquid level.

31. The gas-liquid separator of claim 30, wherein closed vessel is substantially spherical, and wherein the predetermined liquid level is less than the shortest distance between the gas port and the wall of the closed vessel.

32. The gas-liquid separator of claim 31, whereby maintaining the liquid level below the predetermined liquid level prevents the gas port from flooding as a result of a change in the orientation of the closed vessel.

33. The gas-liquid separator of claim 26, further comprising:
an impingement plate disposed in the closed vessel in alignment with the first conduit.

34. The gas-liquid separator of claim 33, wherein the first conduit extends into the central region of the closed vessel.

35. A method for separating gas and liquid under turbulent conditions, comprising:
introducing a fluid stream into a closed vessel, wherein the fluid stream contains a liquid fraction and a gas fraction;
accumulating the liquid fraction along an inner surface of the closed vessel;
discharging accumulated liquid from the inner surface of the closed vessel through a liquid outlet port in the wall of the closed vessel;
removing the gas fraction from a central region of the closed vessel through a port in a gas outlet conduit; and
shielding the gas outlet port to resist liquid entry into the gas outlet conduit as a result of liquid splashing under the turbulent conditions.

36. The method of claim 35, wherein the fluid stream is the outlet from at least one cathode of a hydrogen-oxygen fuel cell.

37. The method of claim 35, wherein the gas outlet port is shielded to resist liquid entry into the gas outlet conduit as a result of liquid splashing in all directions.

38. The method of claim 35, further comprising:
detecting accumulated liquid adjacent the liquid outlet port; and
controlling the amount of accumulated liquid being discharged through the liquid outlet port.

39. The method of claim 38, further comprising:
initiating removal of accumulated liquid upon detecting a high liquid level; and
stopping removal of accumulated liquid upon detecting a low liquid level.

40. The method of claim 38, wherein the closed vessel includes a plurality of liquid outlet ports, the method further comprising:
discharging accumulated liquid through at least one of the plurality of liquid outlet ports where accumulated liquid is detected.
